(19) United States
(12) Patent Application Publication
(10) Pub. No.: US 2022/0343892 A1
(43) Pub. Date: Oct. 27, 2022

(54) SYSTEM AND METHOD FOR SIMULATING VEHICLE ENGINE SOUNDS

(71) Applicant: LIMITED LIABILITY COMPANY "CAR SYSTEMS", Moscow (RU)

(72) Inventors: Evgeny Valerevich TALACHEV, Moscow (RU); Dmitrii Valerevich KUZNETSOV, Moscow (RU); Aleksandr Aleksandrovich SEVASHOV, Odintsovo Moskovskaya obl. (RU)

(21) Appl. No.: 17/637,777

(22) PCT Filed: Aug. 26, 2020
(86) PCT No.: PCT/RU2020/050207

§ 371 Date: Feb. 23, 2022

(30) Foreign Application Priority Data
Aug. 27, 2019 (RU) 2019126961
Aug. 27, 2019 (RU) 2019126962

(51) Int. Cl. G10K 15/02; B60W 40/12; G07C 5/08; H04L 12/40

(52) U.S. Cl. CPC G10K 15/02; B60W 40/12; G07C 5/0833; H04L 12/40; H04L 2012/40215; B60W 2710/06

(57) ABSTRACT

The invention relates to the technologies used in simulating the sounds reproduced by the exhaust system or the burnt gas exhaust system of a vehicle engine. Method of simulating the vehicle engine sounds reproduced by the burnt gas exhaust, characterized in that the recorded or synthesized sound templates are loaded into the electronic control unit located in the vehicle and connected to its CAN circuits, and the recorded sound templates (modified depending on the CAN circuits information) are reproduced through at least one speaker that is part of the acoustic device connected with the electronic control unit. Also, a system for simulating the vehicle engine sounds reproduced by the burnt gas exhaust system is described. The technical result consists in providing high accuracy in generating and simulating of specific vehicle engine sounds reproduced by the burnt gas exhaust system.

### FIELD OF THE INVENTION

The invention relates to the technologies and equipment used in simulating the vehicle engine sounds reproduced by the burnt gas exhaust system.

### BACKGROUND

The prior art discloses a vehicle simulator noise emulator comprising a summing unit the output of which is connected through an amplifier with the input of the sound reproducing unit made in the form of a loudspeaker. Besides, to increase accuracy, the said emulator additionally comprises a starter noise emulator, a heater boiler noise emulator (the said devices made in the form of low-frequency oscillators), a low-frequency generator, a three-phase rectifier, a single-phase rectifier and an internal combustion engine emulator made in the form of a tachometer-generator the first output of which is connected with the first input of the three-phase rectifier and is connected to the first input of the summing unit through the low-frequency generator, wherein the second output of the tachometer-generator is connected with the second input of the three-phase rectifier and is connected to the second input of the summing unit through the single-phase rectifier, wherein the third output of the tachometer-generator is connected with the third input of the three-phase rectifier the output of which is connected to the third input of the summing unit the fourth and fifth inputs of which are connected with the outputs of the low-frequency oscillators of, respectively, the starter' and the heater boiler noise emulators (RU 2066474 C1, Sep. 10, 1996).

The prior art discloses a vehicle driver training simulator comprising a driver's workplace with a front speaker acoustic system and analog controls and the discrete controls mechanically bound with, respectively, the analog position sensors and the discrete position sensors, an engine noise emulating module the output group of which is connected with the input group of a sound generator the output group of which is connected with the front speaker acoustic system input group, a visual environment simulation unit the first input group of which is connected with the first output group of the vehicle movement simulation module the second output group of which is connected with the input group of the engine noise emulator, and the first output group of the visual environment simulation unit is connected with the input group of a visual display device. That said, the simulator additionally comprises a rear speaker acoustic system, a wheel noise emulator, an interface device, a calibration module and a program control module the first and the second output groups of which are connected, respectively, with the first input group of the calibration module and the second input group of the visual environment simulation unit the third input group of which is connected with the first output group of the calibration module the second output group of which is connected with the first input group of the vehicle movement simulation module the second input group of which is connected with the first output group of the interface device the second output group of which is connected with the second input group of the calibration module, the analog position sensors outputs are connected with the analog input group of the interface device, wherein the digital input group of the latter is connected with the outputs of the discrete position sensors, the second output group of the visual environment simulation unit is connected with the third input group of the vehicle movement simulation module the third output group of which is connected with the vehicle noise emulator module, and the output of the latter is connected with the input group of the sound generator the output group of which is connected with the input group of the rear speaker acoustic system (RU 68754 U1, Nov. 27, 2007).

The closest prior art to the claimed invention is the device and the method of its implementation that constitute a sound generator for the exhaust system of a motor vehicle internal combustion engine, the said device comprising a body with an electroacoustic converter unit, a membrane separating the rear part of the body from its front part and a pipe connecting the front part of the sound generator with the exhaust gas pipe, as well as the method of this device operation (CN 104131862 A, Nov. 11, 2014).

The main disadvantage of the known inventions is their repetitiveness during use, i.e., the impossibility of choosing specific sounds reproduced by various vehicles.

### DISCLOSURE OF THE INVENTION

The technical problem to be solved by the proposed invention is the development of the method and system allowing simulating various sounds of a vehicle engine reproduced by the burnt gas exhaust system.

The technical result to be achieved while solving the specified problem consists in providing high accuracy in generating and simulating of specific vehicle engine sounds reproduced by the burnt gas exhaust system.

To achieve the specified technical result, a method of simulating the vehicle engine sounds reproduced by the burnt gas exhaust system has been proposed, characterized in that the recorded or synthesized sound templates are loaded into the electronic control unit located on the vehicle and connected to its CAN circuits, and the recorded sound templates (modified depending on the CAN circuits information) are reproduced through at least one speaker that is part of the acoustic device connected with the electronic control unit.

Also, to achieve the specified technical result, a system of simulation of the vehicle engine sounds reproduced by the burnt gas exhaust system has been proposed consisting of an acoustic device and an electronic control unit comprising recorded of synthesized sound templates, connected to the vehicle CAN circuits and to an acoustic device comprising at least one speaker intended for reproducing the recorded or synthesized sound templates selected from the whole set and modified depending on the CAN circuits information.

Additionally, the system is configured to be attached to the vehicle.

Additionally, the system is configured to interact with the mobile applications installed on a smartphone.

Additionally, the system is configured to interact with the mobile applications installed on a smartphone, through the BLE wireless interface.

Additionally, the system is configured to interact with the applications installed on a personal computer.

Additionally, the system is configured to interact with the applications installed on a personal computer, through the USB connector.

Additionally, the system is configured to use the mode switch buttons located in the passenger compartment, and the recorded or synthesized sound templates.

### BRIEF DESCRIPTION OF THE DRAWINGS

FIG. 1— connection diagram for the acoustic system for simulating the vehicle engine sounds reproduced by the burnt gas exhaust system;

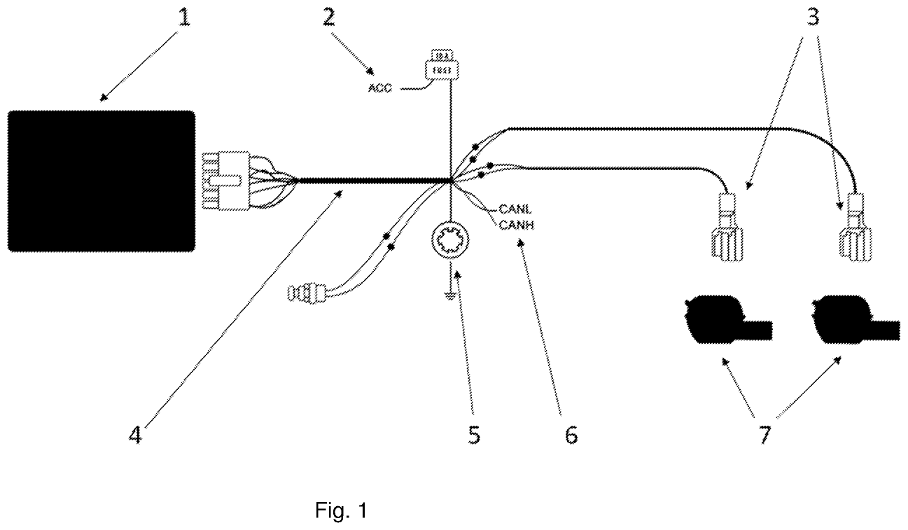

FIG. 2—the acoustic system structure.

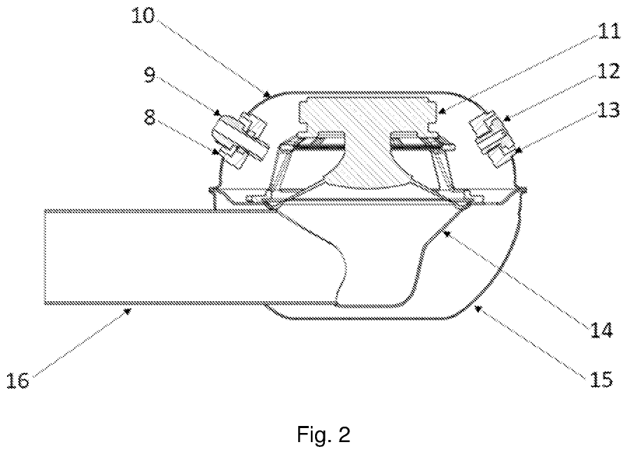

The following elements have been denoted on the drawings by references:
1—control unit;
2—connection to the vehicle ACC wire;
3—electrical connector for connecting the acoustic device;
4—harness with a connector for connecting the control unit;
5—connection to the vehicle chassis ground;
6—connection to the vehicle CAN bus;
7—acoustic device;
8—washer;
9—sealing bushing;
10—upper body cover;
11—speaker;
12—pressure balance valve;
13—washer;
14—internal partition;
15—lower body cover;
16—pipe.

### IMPLEMENTATION OF THE INVENTION

Method of simulating the vehicle engine sounds reproduced by the burnt gas exhaust is implemented as follows.

Preliminarily, sound templates are created by recording the live vehicle sounds, capturing in the process all the engine operating conditions starting from the idle running and finishing with the abrupt acceleration up to the shutoff. The ready-made sound templates in the form of a mobile application are installed on a smartphone with, e.g., Android or iOS operating systems, through a Bluetooth channel and/or on a PC with, e.g., Windows operating system, through the USB connector. That said, a mobile application features a sound templates catalog update function, i.e., a user after logging in to the mobile application downloaded through, e.g., PlayMarket and/or AppleStore using his password obtained during the initial registration can download updates for the vehicle engine sound templates.

After the loaded sound templates are ready to be used, they are transferred from the smartphone and/or personal computer to the main electronic control unit installed on the vehicle and connected to the CAN and ACC circuits thereof, as well as to the vehicle acoustic system (located, e.g., at the bottom of the vehicle) intended for the direct sound reproduction.

After the sound templates have been transferred to the electronic unit, the user selects a specific sound template using a mobile application, adjusts its sound parameters and starts the device. As a result, the recorded sound templates modified depending on the CAN circuits information are reproduced through at least one speaker that is part of the acoustic device.

In the process, it is possible to control the sound templates parameters (e.g., set the volume, the starting sound, the number of «firings», the idling and the operating tones) using a mobile application installed on the smartphone and/or personal computer.

The sound templates can also be controlled using the buttons installed in the vehicle passenger saloon.

Thus, the proposed method allows very accurate generation and simulation of specific vehicle engine sounds reproduced by the burnt gas exhaust system.

The acoustic system for simulating the vehicle engine sounds reproduced by the burnt gas exhaust system consists of the electronic control unit (1) comprising pre-recorded or synthesized sound templates, connected with the help of harnesses (4) and cables to the vehicle circuits, e.g., to the ACC wire (2), to the CAN bus (6) and to the vehicle chassis ground (5), and also (through the electrical connectors (3)) to the acoustic device (7) comprising at least one speaker intended for the reproduction of pre-recorded or synthesized sound templates selected from the whole set and modified depending on the vehicle circuits (CAN circuits).

The system for simulating the vehicle engine sounds reproduced by the burnt gas exhaust operates as follows.

Preliminarily, sound templates are created by recording the real vehicle sounds or by the method of synthesis, capturing in the process all the engine operating conditions starting from the idle running and finishing with the abrupt acceleration up to the shutoff. The ready-made sound templates are installed into the control unit (1) using a mobile application based on the Android or iOS operating systems, or with the help of a personal computer with, e.g, Windows operating system, through the USB connector. That said, the mobile application features a loaded sound templates update function, i.e., a user after connecting to the control unit (1) through a wireless channel can download updates of the vehicle engine sound templates into the said control unit.

After the sound templates have been transferred to the main unit (1), the user selects a specific sound template using a mobile application, adjusts its sound parameters and starts the system. As a result, the recorded sound templates modified depending on the CAN circuits information are reproduced through at least one speaker (11) that is part of the acoustic device (7).

That said, the acoustic system consists of the upper (10) and lower (15) body covers connected together. The upper body cover (10) features a speaker wire sealing bushing (9) attached to it with the help of the washer (8), as well as the pressure balance valve (12) attached with the help of the washer (13). Additionally, a speaker (11) is attached to the inner part of the upper body cover (10). The lower part of the body cover (15) features an internal partition (14) and a pipe (16).

The system is configured to interact with the mobile applications installed on a smartphone and with the applications installed on a personal computer. That having been said, using a mobile application installed on a smartphone, including through the BLE wireless interface, and/or installed on a personal computer, including through the USB connector, it is possible to control the sound templates parameters (e.g., set the volume, the starting sound, the number of «firings» and the idling and the operating tones).

Also, the system is configured to control the pre-recorded or synthesized sound templates parameters using the mode switch buttons installed in the vehicle passenger compartment.

Additionally, the system is configured to be attached to a vehicle, for example, to the bottom of the vehicle.

Thus, the proposed system allows very accurate generation and simulation of specific vehicle engine sounds reproduced by the burnt gas exhaust system.

1. Method of simulating the vehicle engine sounds reproduced by the burnt gas exhaust, wherein the recorded or synthesized sound templates are loaded into the electronic control unit located on the vehicle and connected to its CAN circuits, and the recorded sound templates (modified depending on the CAN circuits information) are reproduced through at least one speaker that is part of the acoustic device connected with the electronic control unit.

2. System for simulating the vehicle engine sounds reproduced by the burnt gas exhaust, wherein it consists of an acoustic device and an electronic control unit comprising the recorded or synthesized sound templates, connected to the vehicle CAN circuits and to an acoustic device comprising at least one speaker intended for reproducing the recorded or synthesized sound templates selected from the whole set and modified depending on the CAN circuits information.

3. System for simulating the vehicle engine sounds reproduced by the burnt gas exhaust according to claim 2, wherein it is configured to be attached to the vehicle.

4. System for simulating the vehicle engine sounds reproduced by the burnt gas exhaust according to claim 2, wherein it is configured to interact with the mobile applications installed on a smartphone.

5. System for simulating the vehicle engine sounds reproduced by the burnt gas exhaust according to claim 4, wherein it is configured to interact with the mobile applications installed on a smartphone, through the BLE wireless interface.

6. System for simulating the vehicle engine sounds reproduced by the burnt gas exhaust according to claim 2, wherein it is configured to interact with the mobile applications installed on a personal computer.

7. System for simulating the vehicle engine sounds reproduced by the burnt gas exhaust according to claim 6, wherein it is configured to interact with the applications installed on a personal computer, through the USB connector.

8. System for simulating the vehicle engine sounds reproduced by the burnt gas exhaust according to claim 2, wherein it is configured to use the mode switch buttons located in the passenger compartment and the recorded or synthesized sound templates.
